(19) United States
(12) Patent Application Publication
(10) Pub. No.: US 2022/0063386 A1
(43) Pub. Date: Mar. 3, 2022

(54) AUTOMOBILE COVER SYSTEM

(71) Applicant: Antonio Rodolfo Aguilar, Signal Hill, CA (US)

(72) Inventor: Antonio Rodolfo Aguilar, Signal Hill, CA (US)

(21) Appl. No.: 17/458,198

(22) Filed: Aug. 26, 2021

Related U.S. Application Data
(60) Provisional application No. 63/070,352, filed on Aug. 26, 2020.

(51) Int. Cl. B60J 11/04

(52) U.S. Cl. CPC B60J 11/04

(57) ABSTRACT

The inventive subject matter provides apparatus, systems, and methods in which a cover can be used to protect an automobile from sun, rain, snow, and other environmental conditions, while providing a storage container to conveniently store and transport the cover. The storage container can be anchored onto an automobile for ease in installing the cover onto the automobile, and such storage container can be hidden underneath the cover when installed on the automobile. The cover can be configured to be coupled to the storage container such that the location of coupling is at least partially hidden along the exterior of cover.

This application claims the benefit of U.S. provisional application No. 63/070,352 filed Aug. 26, 2020. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is an automobile cover system.

### BACKGROUND

The background description includes information that may be useful in understanding the present invention. It is not an admission that any of the information provided herein is prior art or relevant to the presently claimed invention, or that any publication specifically or implicitly referenced is prior art.

Automobile cover systems have existed for many years. Such systems are often used to reduce the risk that an automobile is damaged by environment conditions. Several have contemplated automobile cover systems, including Koh (U.S. Pat. No. 4,596,418), Curchod (U.S. Pat. No. 5,188,417), and Keiji (JP10305734). Although various systems have been developed, there is still a need for automobile cover systems that can be conveniently installed, stored, and transported.

### SUMMARY OF THE INVENTION

The inventive subject matter provides apparatus, systems, and methods in which a cover can be used to protect an automobile from sun, rain, snow, and other environmental conditions, while providing a storage container to conveniently store and transport the cover. It should be appreciated that the storage container can be anchored onto an automobile for ease in installing the cover onto the automobile, and such storage container can be hidden underneath the cover when installed on the automobile.

An automobile cover system is contemplated. The system comprises a storage container and a cover. The cover has a front end and a rear end. The cover is coupled to the storage container at a location between the front end and the rear end. The storage container is sized and dimensioned to store the cover. It should be appreciated that the cover can be removed from the storage container and spread over the storage container to thereby hide the storage container while also covering the automobile.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a side perspective view of an embodiment of an automobile cover system having a cover stored within a storage container.

FIG. 2 is a bottom perspective view of the automobile cover system of FIG. 1.

FIG. 3 is another bottom perspective view of the automobile cover system of FIG. 1.

FIG. 4 is a side perspective view of the automobile cover system of FIG. 1 showing the cover partially removed from the storage container.

FIG. 5 is a side perspective view of the automobile cover system of FIG. 1 showing handles disposed on the cover.

FIG. 6 is a top perspective view of the automobile cover system of FIG. 1 showing the cover unfolded with the storage container hidden underneath the cover.

FIG. 7 is a side perspective view of the automobile cover system of FIG. 1 placed on an automobile.

FIG. 8 is a side perspective view of the automobile cover system of FIG. 1 showing the storage container secured onto the automobile.

FIG. 9 is a side perspective view of the automobile cover system of FIG. 1 showing a first portion of the cover removed and placed onto a front portion of the automobile.

FIG. 10 is a side perspective view of the automobile cover system of FIG. 1 showing a second portion of the cover partially removed.

FIG. 11 is a side perspective view of the automobile cover system of FIG. 1 showing the cover placed on the automobile.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

Also, as used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

The inventor has discovered automobile cover systems comprising a cover and a storage container in which the cover can be housed. Contemplated automobile cover systems can comprise a coupling element (e.g., stitching, an adhesive, a fusible, etc.) that couples a portion of the cover with a surface (e.g., a bottom surface) within the storage container. For example, stitching can be used to fasten a portion of the cover between the front and rear ends of the cover to the storage container. In such embodiments, it is contemplated that the cover is thereby separated into (1) a front portion that extends from the stitching to the front end of the cover, and (2) a rear portion that extends from stitching to the rear end of the cover. The front portion is sized and dimensioned to cover a first area of an automobile, and the rear portion is sized and dimensioned to cover a second area of the automobile. It should be appreciated that the storage container remains hidden underneath the cover when the front and rear portions of the cover the automobile.

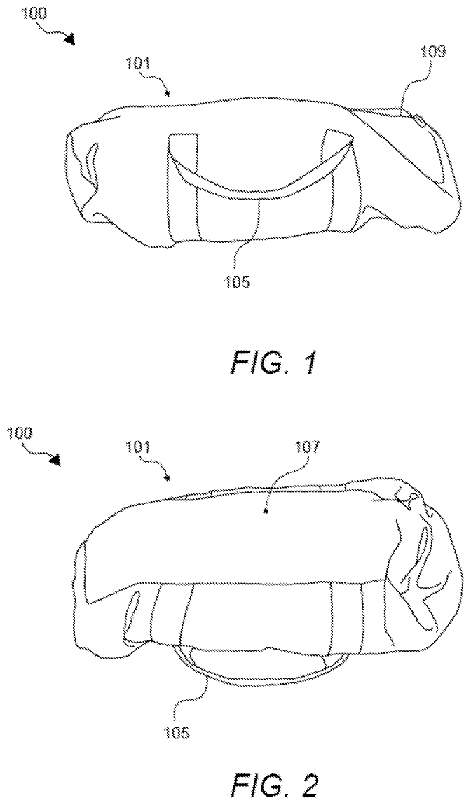

FIG. 1 shows an embodiment of an automobile cover system 100 comprising a storage container 101 and a cover 103 (stored within storage container 101 in FIG. 1). Storage container 101 comprises a handle 105 that can be used to lift and transport automobile cover system 100. It is contemplated that storage container 101 can comprise a second handle for ease in lifting automobile cover system 100. Additionally, or alternatively, storage container 101 can comprise a fastener 109 that can be used to securely enclose cover 103 within storage container 101. As shown in FIG. 1, fastener 109 can be a zipper used to open or close storage container 101. However, in other embodiments, fastener 109 can be a hook-and-loop fastener, a plurality of buttons, or snap fasteners.

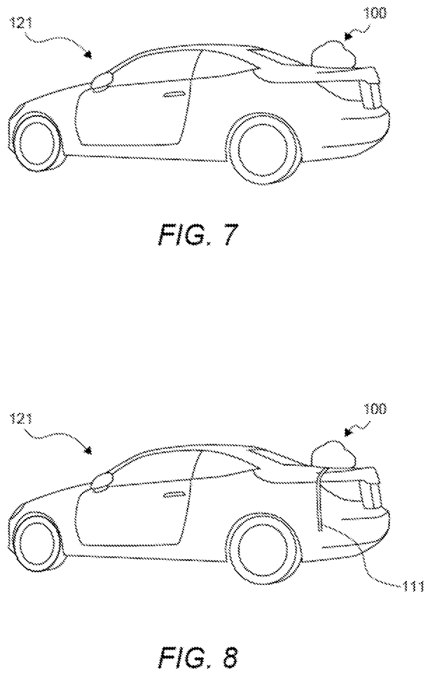

Storage container 101 can made of a natural or synthetic fabric. Storage container 101 can comprise first and second different materials. For example, bottom 107 of storage container 101 can comprise a first material, and another portion of storage container 101 (e.g., sides, front, and rear) can comprise a second material as shown in FIG. 2. It is contemplated that the first material can be felt and/or the second material can be canvas or leather. It should be appreciated that felt or a soft material on bottom 107 of storage container prevents or reduces the risk of scratches or other damage to the automobile when bottom 107 rests on the automobile as storage container 101 is placed and anchored onto the automobile during installation or removal of cover 103 (see FIGS. 7-11).

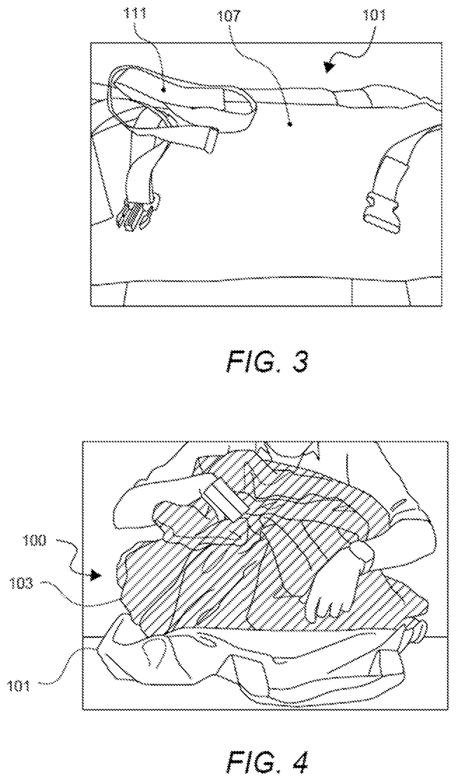

Storage container 101 can further comprise a strap 111 as shown in FIG. 3. Strap 111 comprises a fastener (e.g., a side squeeze buckle as shown in FIG. 3) to removably couple a first portion of strap 111 with a second portion of strap 111. It is contemplated that the first and second portions of strap 111 are disposed on opposite ends of storage container 101 or bottom 107. For example, the first portion of strap 111 can be coupled to a front end of storage container 101 or first end of bottom 107 and the second portion of strap 111 can be coupled to a rear end of storage container 101 or second end of bottom 107. In some embodiments, strap 111 can be an elastic material. Although strap 111 is shown as two separate portions in FIG. 3, it is contemplated that strap 111 can be a single belt having first and second ends coupled to front and rear ends of storage container 101, respectively, wherein the single belt can be stretched around a trunk lid of an automobile.

Storage container 101 is sized and dimensioned to store cover 103. FIG. 4 shows automobile cover system 100 having cover 103 partially removed from within storage container 101. A user can simply use fastener 109 to open storage container 101, and pull cover 103 out of storage container 101. To store cover 103, a user can fold or otherwise place cover 103 within storage container 101, and close storage container 101 using fastener 109.

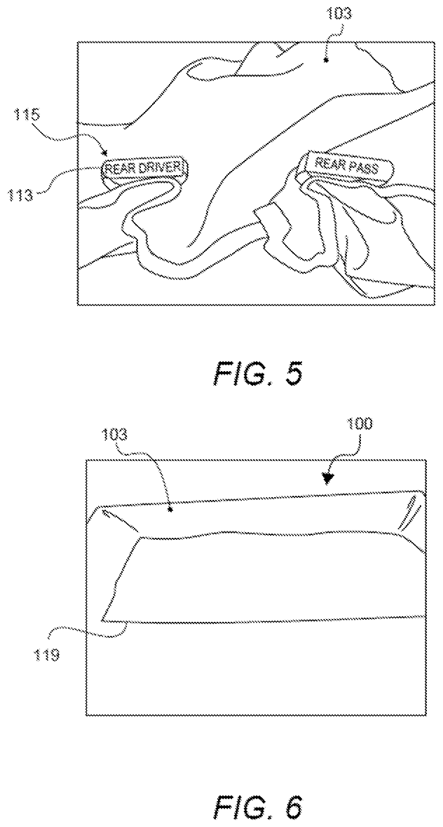

Cover 103 comprises various handles that can be used to place cover 103 onto an automobile. Additionally, or alternatively, one or more of the handles can comprise a label that indicates where the handle, and the proximal portion of cover 103 to such handle, should be positioned with respect to the automobile. For example, FIG. 5 shows cover 103 comprising a first handle 113 having a label 115 that reads “rear driver” to inform a user to position handle 113 on the rear driver side of the automobile. Other contemplated labels for a handle include “front driver”, “rear pass”, “front pass”, and other such labels that would indicate to a user where to position such handle with respect to an automobile.

FIG. 6 shows cover 103 removed from storage container 101. Cover 103 can be unfolded or spread out from a bunched or folded configuration when within storage container 101 to hide storage container 101 underneath cover 103 as shown in FIG. 6. It is contemplated that storage container 101 and cover 103 are coupled via a coupling 119. Thus, cover 103 can be secured onto storage container 101 to prevent cover 103 from being misplaced or otherwise lost.

It is contemplated that coupling 119 is at a location within an outer border of cover 103 to allow cover 103 to unfold to cover an automobile and storage container 101. As shown in FIG. 6, coupling 119 is within an outer border of cover 103 (and within front and rear ends of cover 103) to thereby allow cover 103 to unfold over the sides, and the rear and front walls of storage container 101 and completely hide storage container 101 underneath cover 103. In some embodiments, coupling 119 couples cover 103 onto bottom 107 of storage container 101. For example, it is contemplated that coupling 119 couples cover 103 onto the outer border of bottom 107 of storage container 101.

Advantageously, the location of coupling 119 within the outer border of cover 103 allows storage container 101 to be hidden below cover 103 after cover 103 is installed onto an automobile. It should be appreciated that this eliminates the need for finding a separate storing area for the storage container, and it reduces the risk of theft of the storage container due to its hidden nature (i.e., the storage container is hidden from view, underneath the cover). In a preferred embodiment, coupling 119 can be stitches as shown in FIG. 6. The stitches can fasten cover 103 onto storage container 101 (e.g., onto a bottom surface within storage container 101). It is contemplated that cover 101 can thereby be separated into (1) a front portion that extends from the stitching to the front end of the cover, and (2) a rear portion that extends from stitching to the rear end of the cover. The front portion is sized and dimensioned to cover a first area of an automobile, and the rear portion is sized and dimensioned to cover a second area of the automobile

In another embodiment, coupling 119 can be a fusible. For example, coupling 119 can be a heat-sensitive tape, or an adhesive.

The following figures provide an exemplary installation process for automobile cover system 100. FIG. 7 shows automobile cover system 100 placed on a trunk lid of automobile 121. Bottom 107 of storage container 101, preferably made of felt or another soft material, rests on the trunk lid. A user can then fasten strap 111 around the trunk lid of automobile 121 to anchor storage container 101 to the trunk lid as shown in FIG. 8.

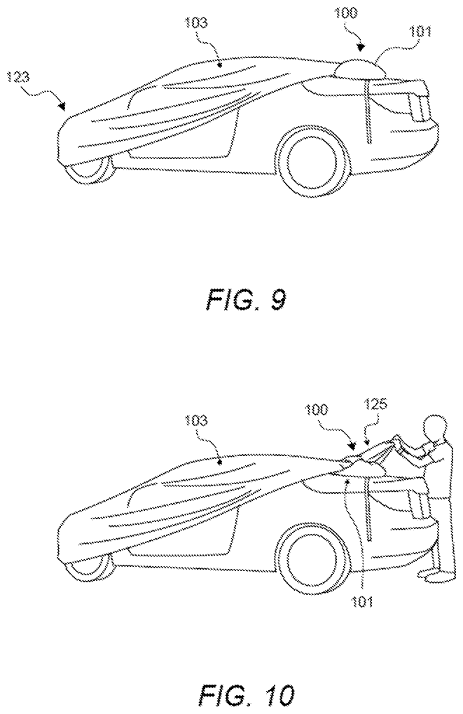

Once anchored, the user can remove a front portion 123 of cover 103 to place onto a front portion of automobile 121 as shown in FIG. 9. Front portion 123 of cover 103 also covers a portion of storage container 101. It is contemplated that front portion 123 of cover 103 can be the area of cover 103 that extends from coupling 119 (e.g., stitching) to the front end of cover 103.

As shown in FIG. 9, storage container 101 generally remains in the same position where it is anchored using strap 111 as shown in FIG. 8. A user can then remove a rear portion 125 of cover 103 as shown in FIG. 10. It is contemplated that rear portion 125 can be the area of cover 103 that extends from coupling 119 (e.g., stitching) to the rear end of cover 103.

Although these figures show front portion 123 of cover 103 being removed prior to rear portion 125 of cover 103, it is contemplated that a user can install cover 103 in a reverse order (i.e., removing rear portion 125 prior to front portion 123).

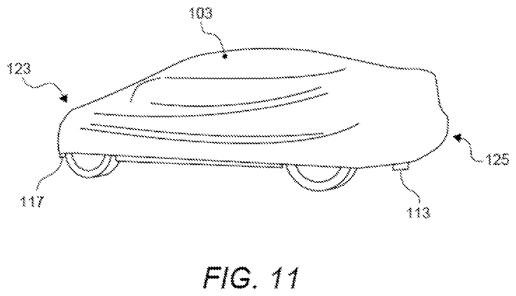

Rear portion 125 of cover 103 can be pulled over the remaining portion of storage container 101 and the rear portion of automobile 121 to thereby cover automobile 121 and storage container 101 as shown in FIG. 11. Although not shown, storage container 101 generally remains in the same position where it is anchored using strap 111 as shown in FIG. 8, but now is hidden underneath cover 103.

It should be appreciated that a user can use handles to install cover 103 onto automobile 121 and also remove cover 103 from automobile 121. As shown in FIG. 11, cover 103 can comprise first handle 113 on a rear portion 125 of cover 103, and a second handle 117 on a front portion 123 of cover 103. As discussed above, first handle 113 can comprise label 115 that reads “rear driver” which is where first handle 113 is disposed in FIG. 11. It is contemplated that second handle 117 comprises a label that informs a user to position such handle near the front driver side of automobile 121 (e.g., a label that states “front driver”). Additionally, it is contemplated that cover 103 can comprise two handles on the passenger side of automobile with or without labels to inform user to position such handles on the front or rear passenger side of automobile 121. Such handles can be used to remove cover 103 from automobile 121, and cover 103 can then be placed in storage container 101 for storage and transport.

Thus, an automobile cover system is contemplated that provides users the ability to conveniently store and transport a cover in a storage container.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. An automobile cover system, comprising:
a storage container;
a cover having a front end and a rear end;
wherein the cover is coupled to the storage container at a location between the front end and the rear end; and
wherein the storage container is sized and dimensioned to store the cover.

2. The automobile cover system of claim 1, wherein the storage container comprises a handle.

3. The automobile cover system of claim 1, wherein the cover comprises a first handle.

4. The automobile cover system of claim 3, wherein the first handle comprises a first label.

5. The automobile cover system of claim 3, wherein the cover comprises a second handle, and wherein the first handle is disposed on the rear end and the second handle is disposed on the front end.

6. The automobile cover system of claim 5, wherein the first handle comprises a first label and the second handle comprises a second label.

7. The automobile cover system of claim 5, wherein the cover comprises a third handle disposed on the front end and a fourth handle disposed the rear end.

8. The automobile cover system of claim 7, wherein the first handle comprises a first label, the second handle comprises a second label, the third handle comprises a third label, and the fourth handle comprises a fourth label.

9. The automobile cover system of claim 1, wherein the storage container comprises a strap.

10. The automobile cover system of claim 9, wherein the strap comprises a fastener to removably couple a first portion of the strap with a second portion of the strap.

11. The automobile cover system of claim 10, wherein the first and second portions of the strap are disposed on opposite ends of the storage container.

12. The automobile cover system of claim 9, wherein the strap comprises an elastic material.

13. The automobile cover system of claim 1, wherein storage container comprises a fastener to thereby open or close the storage container.

14. The automobile cover system of claim 13, wherein the fastener comprises a zipper or a hook-and-loop fastener.

15. The automobile cover system of claim 1, wherein the storage container further comprises a felt material on an exterior surface.

16. The automobile cover system of claim 1, wherein the cover is coupled to the storage container via at least one of an adhesive, a stitching, and a fusible.
